(19) United States
(12) Patent Application Publication
(10) Pub. No.: US 2007/0148292 A1
(43) Pub. Date: Jun. 28, 2007

(54) COATED CHEWY CONFECTIONERY PRODUCT AND METHOD

(76) Inventors: Angel Palomes Royo, Sabadell (ES); Marguerite Yang, Wilmette, IL (US)

Correspondence Address: BELL, BOYD & LLOYD LLP, P.O. Box 1135, CHICAGO, IL, 60690, US

(21) Appl. No.: 11/610,200

(22) Filed: Dec. 13, 2006

Related U.S. Application Data
(60) Provisional application No. 60/752,286, filed on Dec. 21, 2005.

(51) Int. Cl. A23G 3/20

(52) U.S. Cl. 426/103

(57) ABSTRACT

The present disclosure provides a confectionery product having a crunchy, hard-coated outer shell that encases a chewy core portion. The core portion may include one or more of gel components. Each gel component may contain a gelling agent and a flavor. The gelling agents for each gel component may have a different property to provide each gel component with a different flavor release rate upon mastication thereby producing waves of flavor throughout the entire product chew. In addition, the coating portion may include a sensation producing ingredient that provides an initial sensory burst to the consumer.

### PRIORITY CLAIM

This application claims the benefit of U.S. Provisional Patent Application Ser. No. 60/752,286 filed on Dec. 21, 2005, the entire content of which is incorporated by reference herein.

### BACKGROUND

In the confectionery art, continual efforts are directed toward producing attractive and flavorful candy products. A wide variety of chewy candies are known such as gummy type candies, jelly beans, and chewy mints. The flavor profile for such candies typically include one flavor in the candy center and optionally a second flavor in the coating, if a coating is present. The chew characteristic for these candies typically entails a short mastication duration, typically about 1 to 2 minutes. Thus, a need exists for a coated chewy candy with a longer and more appealing flavor profile and a longer chew duration. A need further exists for a coated chewy confectionery product that provides waves of flavor throughout the entire chew.

### SUMMARY

The present disclosure provides an attractive gel-type or jelly candy, intense in flavor, with an extended chew duration. The present confectionery product provides waves of flavor throughout the entire product chew. In addition, the present confectionery product provides an appealing crunchy outer coating with an invigorating sensory burst, with the core portion delivering waves of uplifting flavors after the initial sensory burst.

The present disclosure provides a coated confectionery product that includes a core portion and a coating portion that surrounds or otherwise encases the core portion. The core portion may include one or more gel components. Each gel component may include a gelling agent, a sweetener, a flavorant, a colorant, and combinations thereof. In an embodiment, the gelling agent may be gelatin. In an embodiment, the core portion may include a first gel component having a first flavor and a second gel component having a second flavor. Upon mastication, the second gel component delivers the second flavor to the chewer's mouth before the first gel component delivers the first flavor to the mouth. In a further embodiment, the first flavorant may be delivered after substantially all of the second flavorant is delivered to the consumer's mouth.

In an embodiment, the second gel component surrounds or encases the first gel component. The second gel component may deliver the second flavor to the consumer's mouth before the first gel component delivers the first flavor to the consumer. In a further embodiment, a third gel component surrounds the second gel component. Upon initiation of mastication of the confectionery product, the third gel component may deliver a respective third flavor to the consumer's mouth before delivery of either the second flavor from the second gel component and/or delivery of the first flavor from the first gel component.

In an embodiment, the first gel component may have a flavor release rate that is slower than or is otherwise less than the flavor release rate of the second gel component. Flavor delivery or the flavor release with respect to each gel component may be varied by altering one or more properties of the gelling agent in the gel component. In addition, flavor release rate may be varied by using encapsulated flavorants, unencapsulated flavorants, and combinations thereof. In an embodiment, the gelling agent may be gelatin. In a further embodiment, the first gel component may include a first gelatin and the second gel component may include a second gelatin. The first and second gelatins may differ in one or more properties such as Bloom value, pH, viscosity, density, molecular weight, water activity, solubility, solids content, moisture content, and combinations thereof. The property differences between the first and second gelatins may provide respective first and second gel components with different flavor delivery times during mastication. Alternatively, the first and second gelatins having different properties may provide respective first and second gel components having different flavor release rates. Encapsulated and unencapsulated flavorants may be used with the differing gelatins to further provide the introduction of flavors at discrete time points during mastication.

In an embodiment, the coating portion may include a sweetener, a flavorant, a film forming agent, a colorant, a sensation producing ingredient, and combinations thereof. In an embodiment, the sweetener may be isomalt. In an embodiment, isomalt may also be the coating material. The isomalt may be present in an amount from about 15% to about 98% by weight of the coating portion. In an embodiment, the coating component may be a hard, crunchy coating.

In a further embodiment, the coating portion further comprises an outer layer and an inner layer. Each layer may include a sensation producing ingredient which may be a cooling agent, a food grade acid, a flavorant, a sweetener, or any combination thereof. The sensation producing ingredient may be delivered to the consumer's mouth within about 1 second to about 10 seconds upon initial mastication of the confectionery product. The ingredients in each layer may be the same or different. In an embodiment, the inner layers may be a precoating such as a dust layer or soft pan coating. In a further embodiment, the outer layer may be a hard pan coating. The outer coating layer may be present with or without the inner layer.

In yet a further embodiment, a coated confectionery product is provided that includes a first gelatin-based gel component having a first flavor and a second gelatin-based gel component having a second flavor. The first and second gel components may be combined to form a core portion. The confectionery product may further include a coating component that encases the core portion. The first gel component may be prepared with a gelling agent that has a strong gel strength to provide the first gel component with a delayed flavor release. The second gel component may be prepared with or may otherwise contain a gelling agent that has a weaker gel strength so that the second gel component has a substantially immediate flavor release upon mastication of the coated confectionery product. The coating component may include a sensation producing ingredient that is delivered to the mouth of a consumer before delivery of the second flavor from the second gel component.

In yet a further embodiment, a method for delivering a plurality of flavors to the mouth of a consumer is provided. The method includes providing a coated confectionery product. The coated confectionery product includes a core portion having a first gel component with a first flavor and a second gel component with a second flavor. The core portion is coated with a coating portion. The method further entails delivering upon mastication the first flavor from the first gel component upon mastication, and delivering upon mastication the second flavor from the second gel component before the delivering of the first flavor.

In an embodiment, substantially all of the second flavor is delivered to the chewer's mouth before delivery of the first flavor occurs.

In an embodiment, the method includes surrounding the first gel component with the second gel component.

In an embodiment, the method includes preparing the first gel component with a first gelatin having a first flavor release rate, and preparing the second gel component with a second gelatin having a second flavor release rate that is greater than or otherwise more rapid than the first flavor release rate.

In an embodiment, the method may include preparing the first gel component with a first gelatin having a delayed flavor release and preparing the second gel component with a second gelatin having an immediate flavor release. The method may further include delivering substantially all of the second flavor before the delivery of the first flavor to the consumer's mouth.

In an embodiment, the coating component may include a sensation producing ingredient. The method may entail delivering the sensation producing ingredient upon mastication of the confectionery product before the delivery of the first flavor and/or the second flavor to the person's mouth.

In an embodiment, the confectionery product is sugar-free.

In an embodiment, the average mastication duration of the confectionery product is from about 3 minutes to about 10 minutes.

The present confectionery product advantageously provides a chewy product that delivers discrete waves of flavor to the consumer. The flavors may overlap. Alternatively, the product may be prepared to deliver a new flavor after substantially all of an initial flavor has been delivered to the person's mouth. This further increases the sense of distinct flavor waves upon the chewer, contributing to the enjoyment and appeal of the present product. The present confectionery product further advantageously provides a hard crunchy coating. The coating breaks away upon initial mastication to introduce a flavor or a sensation producing ingredient substantially immediately upon placement of the product in the mouth of the consumer.

Additional features and advantages are described herein, and will be apparent from, the following Detailed Description and the Figures.

### BRIEF DESCRIPTION OF THE FIGURES

FIG. 1 is perspective view of a coated confectionery product in accordance with the present disclosure.

FIG. 2 is a break-away perspective view of the coated confectionery product of FIG. 1.

FIG. 3 is a sectional view taken along line 3-3 of FIG. 1.

FIG. 4 is a sectional view of an embodiment of the coated confectionery product of the present disclosure.

FIG. 5 is a sectional view of another embodiment of the coated confectionery product of the present disclosure.

FIG. 6 is a sectional view of a further embodiment of the coated confectionery product of the present disclosure.

### DETAILED DESCRIPTION

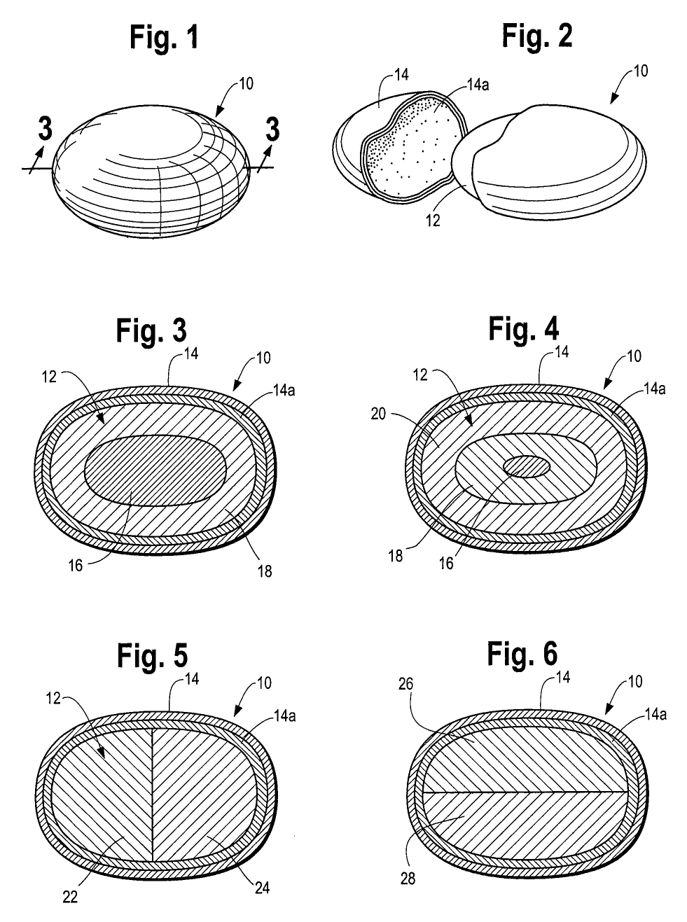

Referring to the Figures generally, where like reference numerals denote like structure and elements, and in particular to FIGS. 1 and 2, a confectionery product 10 having a core portion 12 and a coating portion 14 is shown. Core portion 12 may include one or more gel components. In an embodiment, core portion 12 may include a plurality of gel components as shown in FIG. 3. Although FIG. 3 shows first gel component 16 and second gel component 18, the number of the gel components may range between 2, 3, 4, 5 or 10 or more as desired. In addition, the configuration of the gel components within core portion 12 may be varied as will be discussed below.

Each gel component may include a gelling agent, a sweetener, a flavorant, a colorant, a cooling agent, and any combination thereof. The sweetener may be sugar, sugar-based, or be sugar-free. Nonlimiting examples of sugar sweeteners include, but are not limited to, saccharide-containing components such as sucrose, dextrose, maltose, dextrin, dried invert sugar, fructose, levulose, galactose, corn syrup, corn syrup solids, and the like, alone or in combination, as are commonly known in the art. In an embodiment, the gel component may include sugarless bulk sweeteners including such nonlimiting examples as sugar alcohols such as sorbitol, erythritol, mannitol, isomalt, xylitol, hydrogenated starch hydrolysates, maltitol, and the like, alone or in combination. The amount of bulk sweetener present in the confectionery product may be from about 30% to about 90%, or about 50% to about 85% by weight of the gel component.

In an embodiment, the sweetener may further include a high intensity sweetener including such non-limiting examples as sucralose, aspartame, salts of acesulfame, alitame, saccharin and its salts, neotame, cyclamic acid and its salts, glycyrrhizin, dihydrochalcones, thaumatin, monellin, and the like, alone or in combination. In an embodiment, the gel component may be sugar-free. The amount of high intensity artificial sweetener may be present from about 0.1% to about 4.0% of the gel component. In an embodiment, confectionery product 10 may be sugarless.

The flavorant or flavor of the gel component may include any natural or synthetic oil and/or flavor as is commonly known in the art. Suitable flavorants include, but are not limited to, oils derived from plants and fruits such as citrus oils; fruit essences; fruit juices, fruit concentrates, fruit purees, of berry, lemon, strawberry, orange, and/or apple; peppermint oil; spearmint oil; other mint oil; clove oil; oil of wintergreen; anise; flavors derived from spices and the like; flavor oils with germ killing properties such as menthol eucalyptol, thymol, methyl salicylate, licorice, cinnamic aldehyde; like flavoring agents or combinations thereof and the like. Artificial flavoring agents and components may also be used as the flavorant or flavor. Natural and artificial flavoring agents may be combined in any sensorally acceptable fashion as is commonly known in the art. The flavorant or flavor may be encapsulated or non-encapsulated. Encapsulated flavorant may be used to increase or decrease the flavor release rate as is commonly known in the art.

The gel component may further include any natural or artificial gelling agent as is commonly known in the art. Nonlimiting examples of suitable gelling agents include agar, alginates, amylose, high amylose starch, gum arabic, carrageenan, gellan gum, guar gum, gelatin, ghatti gum, karaya gum, gluten, konjac, levan, locust bean gum, maltodextrin, pectin, low methoxy pectin, modified starches, and combinations thereof. The gelling agent may be present from about 0.1% to about 25% by weight, or about 13% to about 23% by weight or about 16% to about 19% by weight of the gel component.

In an embodiment, the gelling agent may be a gelatin. Gelatin is a heterogeneous mixture of water-soluble high molecular weight proteins and is prepared by the thermal denaturation of collagen, isolated from animal and fish skin and bones. The molecular weight of gelatin protein structures ranges between about 20,000 to about 250,000. The water activity of gelatin may range from about 0.5 to about 0.95. The isoelectronic point of gelatin typically ranges between 4.8 and 9.4. The Bloom gel strength of gelatin may range between 90 grams to 325 grams.

Two types of gelatin exist. Type A, with an isoelectronic point that typically ranges between 7 to 9, is derived from pigskin collagen with acid pretreatment. The pH in water solutions for type A gelatin is between about 3.8 and about 6. Type B, with an isoelectronic point that typically ranges between 4.8 to 5.2, is the result of an alkaline pretreatment of cattle collagen. The pH in water solutions for type B gelatin is from about 5 to about 7.5.

In an embodiment, the gelling agent may be an alginate. Alginates typically require calcium and/or low shear to gel. Calcium concentration and processing shear parameters may be altered as desired to correspondingly alter the gel firmness to adjust the product disintegration rate and/or flavor release. In an embodiment, alginate may be present from about 0.1-1.0% by weight of the gel component.

In an embodiment, the gelling agent may be a carrageenan. Carrageenans are linear galactan polysaccharides, derived from red seaweed. Three types of carrageenan exist: kappa, iota, and lambda. Iota carrageenan may be utilized to produce a chewy, elastic gel component. Kappa carrageenan may be used to produce a brittle gel component. The gel strength of an iota carrageenan-based gel component typically increases with an increased amount of calcium ion concentration whereas the gel strength of a kappa carrageenan-based gel component typically increases with an increased amount of potassium ion concentration as is commonly known in the art. In an embodiment, carrageenan may be present from about 0.2-1.5% by weight of the gel component.

In an embodiment, the gelling agent may be locust bean gum. Locust bean gum is a linear molecule with a mannose backbone with irregular galactose side chains and is derived from the seeds of a carob tree. Not wishing to be bound by any particular theory, locust bean gum appears to synergistically interact with kappa carrageenan to form a gel component with a higher elasticity than is possible with kappa carrageenan alone. It is understood that as gel elasticity increases, the product disintegrataion rate decreases as does the flavor release rate. In an embodiment, locust bean gum may be present from about 0.5%-2.5% by weight of the gel component.

In an embodiment, the gelling agent may be gellan gum. Gellan gum is a water soluble polysaccharide produced by fermentation. Low acyl gellan gum produces a brittle gel whereas high acyl gellan gum produces an elastic gel as is commonly known in the art. Mixtures of low acyl and high acyl gellan gum may be used to adjust the confectionery product disintegration rate during mastication. Shear applied during processing may be used to form a softer gellan gum-based gel component, resulting in a faster confectionery product disintegration rate. In an embodiment, gellan gum may be present from about 0.1-0.5% by weight of the gel component.

In an embodiment, the gelling agent may be pectin. Pectin is a linear polysaccharide extracted from plants, such as citrus fruit peels or apples, for example. Three classifications of pectin exist: HM (high ester), LMC (low ester conventional); and LMA (low ester amidated). Acid, shear, and soluble solids (e.g., sugar) may be applied to affect the texture of pectin-based gel components. For example, an increase in calcium ion concentration may increase the gel firmness for gel components made with LMC and/or LMA pectin. An increase in solids content and/or an increase in pH may be used to increase gel firmness for gel components made with HM pectin.

In an embodiment, core portion 12 includes a first gel component 16 and a second gel component 18, each gel component including a respective flavorant or flavor dispersed therein. As shown in FIG. 3, second gel component 18 may surround or otherwise encase first gel component 16. In this embodiment, second gel component 18 is the first component of core portion 12 subjected to mastication when placed in a consumer's mouth. It is understood that mastication includes chewing, sucking, and/or dissolution, either alone or in combination of a foodpiece upon placement in the mouth of a person. Consequently, second gel component 18 delivers or otherwise releases its respective second flavorant into the consumer's mouth before first gel component 16 delivers its respective first flavorant. In other words, the second flavor is the initial flavor from core portion 12 that the person tastes. Continued mastication of core portion 12 subsequently delivers the first flavor from first gel component 16 to the chewer's mouth. It is understood that an overlap of flavor sensation may occur during mastication. In other words the chewer may simultaneously taste the first flavor and the second flavor. It is understood that the first and second flavors may be the same or different.

In an embodiment, the first flavor may be delivered by first gel component 16 after substantially all of the second flavor is delivered by second gel component 18. This advantageously provides the consumer with the sensation of discrete waves of flavor when consuming coated confectionery product 10. This provision of distinct flavor waves may be accomplished by preparing first and second gel components 16 and 18 with respective different gelling agents. By varying one or more properties of the gelling agent of the first and/or second gel components, the first gel component may be prepared to have a delayed flavor release or a slower flavor release rate as compared to the flavor release or flavor release rate of the second gel component. Mastication causes gel components to break up, giving further surface area for dissolving with saliva. Gel component layers that are softer disitegnate faster, thus releasing flavor to saliva faster. Tougher, more cohesive gel component layers take more mastication to dissolve and thus release flavors slower. In an embodiment, encapsulated flavorants may be used to increase or decrease the flavor release rate from the gel component. For example, first component 16 may contain encapsulated flavorant to delay the flavor delivery therefrom. Second gel component 18 may contain unencapsulated flavorant to provide a relatively more rapid flavor delivery therefrom. It is understood that each gel component may include more than one flavor/flavorant particularly when encapsulated flavorant, unencapsulated flavorant, and combinations thereof are utilized.

In an embodiment, first and second gel components 16 and 18 may be prepared with respective first and second gelatins. It is understood that the gel strength of gelatin is based on such gelatin properties as Bloom value, pH, viscosity, density, molecular weight, water activity, solubility, solids content, and moisture content. For instance, gelatin gel strength and viscosity gradually weaken upon prolonged heating in solution above about 40° C. In addition, degradation of gel strength and viscosity may result upon exposure of gelatin to extreme pH environments. Moreover, an increase in Bloom value typically results in an increase in gelatin gel strength. Indeed, the Bloom value is related to the molecular weight of gelatin as set forth below.

| Bloom Number | Average Molecular Weight |
|---|---|
| 50-125 (Low Bloom) | 20,000-25,000 |
| 175-225 (Medium Bloom) | 40,000-50,000 |
| 225-325 (High Bloom) | 50,000-100,000 |

By varying one or more of the aforementioned properties between the first and second gelling agents, the flavor release and/or the flavor release rate of the first and second gel components may be altered. For example, the skilled artisan will recognize that an increase in solids content in the gelling agent increases the gel strength. Not wishing to be bound to any particular theory, it is believed that gelatin entraps flavor/flavorant within its structure. The greater the gel strength, the stronger the flavor is bound within the gelatin. Hence, increasing the gel strength of the gelatin may correspondingly, slow, delay, or retard, the release rate of flavor from the gel component. In other words, the delivery of flavor from a gel component may be delayed or the flavor release rate may be decreased by incorporating a gelatin with a strong gel strength in the gel component. Similarly, the flavor release rate or the delivery of flavor from a gel component may be increased by diminishing the gel strength of the gelatin. For example, first gel component 16 may be prepared with a suitable strong gelling agent or gelatin to deliver the first flavor in a delayed manner or with a lesser or slower release rate when compared to the second gel component having a gelling agent with a relatively weaker gel strength and corresponding earlier flavor delivery or faster flavor release rate.

For example, first gel component 16 may include a high molecular weight first gelatin that delivers or otherwise releases a first flavor after about 3 to 4 minutes of mastication. Second gel component 18 may include a second gelatin with a molecular weight less than the molecular weight of the first gelling agent. Second gelling agent 18 may deliver or otherwise release the second flavor within about 1 to 2 minutes of mastication. This provides distinct flavor waves to the consumer when chewing confectionery product 12.

In a further embodiment, confectionery product 10 may include a core portion having a third gel component 20 that substantially surrounds or otherwise encases second gel component 18 as shown in FIG. 4. Third gel component 20 may include a respective third flavor/flavorant that may be delivered before both the second flavor of second gel component 18 and/or the first flavor of first gel component 16. A flavor overlap may exist between some or all of the first, second, and third flavors. In an embodiment, the gel components are prepared so that third gel component 20 delivers substantially all of the third flavor before delivery of the second flavor from second gel component 18. Second gel component 18 may or may not deliver substantially all of the second flavor before delivery of any of the first flavor from first gel component 16. This advantageously provides the consumer with three distinct flavor waves bringing further enjoyment to the consumption of confectionery product 10. It is understood that the first, second, and third flavors may be the same or different.

In an embodiment, core portion 12 has first gel component 22 that is disposed adjacent to second gel component 24 has shown in FIG. 5. As is apparent in FIG. 5, confectionery product 10 having this configuration will expose gel components 22 and 24 of core portion 12 to the consumer's mouth substantially simultaneously. In an embodiment, core portion 12 may be prepared so that first and second gel components 22 and 24 release their respective first and second flavorants at different times during mastication. This may be accomplished by varying one or more properties of the respective first and second gelling agents as previously discussed. For example, first gel component 22 may include a gelling agent, such as gelatin, having an increased gel strength with respect to the gel strength of the gelling agent incorporated in second gel component 24. Consequently, core portion 12 may be prepared to provide first gel component 22 with a first flavor release rate that is less than or otherwise slower than the second flavor release rate for second gel component 24. Upon mastication, second gel component 24 may thereby deliver some or all of the second flavor before delivery of the first flavor from first gel component 22. Encapsulated flavorants, non-encapsulated flavors and combinations thereof may be used to further delineate between the delivery of the first and second flavors and/or the release rate of the first and second flavors. It is understood that the first and second flavors may be the same or different.

In a further embodiment, core portion 12 may include first gel component 26 that may be laminated to, coextruded with, or layered upon second gel component 28 as shown in FIG. 6. As is apparent in FIG. 6, first and second gel components 26 and 28 are masticated substantially simultaneously. The first and second flavor deliveries or flavor release rates from first and second gel components 26 and 28 may be varied to provide discrete flavor waves of the first and second flavors as previously discussed herein.

Core portion 12 may be prepared by boiling a mixture of mixed sugars or sweeteners which may then be blended with the gelling agent and processed into any of a wide array of shapes by depositing into starch molds by way of a Mogul process, as is commonly known in the art. Core portion 12 may be shaped into spheres, hemispheres, cubes, tablets, cuboids, lentils, teardrops, pyramids, pastilles, cylinders, or any shape as desired. Core portion 12 may be cured to form the gel structure of the gel components. Core portion 12 may be optionally heated to remove excess moisture. Cooling of core portion 12 may assist in forming a gel structure that is able to withhold its individual shape. In an embodiment, the water content of core portion 12 may be from about 10% to about 20%, or about 15% to about 17% by weight of the core portion.

Core portion 12 may be coated with coating portion 14 as shown in FIGS. 1 and 2. In an embodiment, the coating portion may include any suitable coating material such as, for example, sugars, polyols, or combinations thereof to form a crystalline or glassy coating around core portion 12. The sugars or polyols may be, for example, a component of a syrup or spray that is applied to form coating component 14. Coating portion 14 may or may not be polished as is commonly known in the art.

Coating portion 14 may include other ingredients such as a sweetener, a flavorant, a film forming agent, a colorant, a sensation producing ingredient, and combinations thereof. The sweetener for the coating portion may be sugar, sugar-based, or sugar-free. Non-limiting examples of suitable sweeteners include, maltitol, sorbitol, erythritol, mannitol, isomalt, lactitol, xylitol and combinations thereof. High intensity sweeteners may also be utilized in the coating portion. The coating portion may be present in an amount of from about 20% to about 80% by weight of the confectionery product.

In an embodiment, the coating material may be isomalt. Isomalt is advantageous as it has low hygroscopicity and absorbs virtually no moisture at ambient conditions. For example, isomalt absorbs virtually no moisture at a temperature of 25° C. and relative humidities up to 85%. Isomalt serves as an excellent moisture barrier between the coating portion and the core portion as virtually no moisture migrates from the core portion to the coating portion. This advantageously provides confectionery product 10 with a hard crunchy outer shell while maintaining a chewy center portion. The presence of isomalt in the coating portion further advantageously provides for a hard outer shell coating that does not absorb moisture from the core component which typically has a higher moisture content. Thus, coated confectionery product 10 maintains a hard crunchy outer shell making the confectionery product 10 highly stable when stored. In an embodiment, the isomalt may be present in an amount from about 15% to about 98% by weight of coating portion 14.

Coating portion 14 may be formed to surround or encase core portion 12 by applying to core portion 12 a coating syrup which contains a sweetener such as isomalt and/or another non-sugar sweetener, an adhesion or binder component and a film-forming component. The coating syrup may be applied to core portion 12 after applying a precoating to the outer surface of core portion 12. The precoating may be a powder, or a powder and a syrup, in one or more layers as is commonly known in the art. The precoating may include one or more sweeteners, such as those employed in the coating syrup, but in powdered form. The precoating may optionally include a moisture absorbing component, an anti-sticking component and/or a dispersing agent. In an embodiment, the precoating may include isomalt. A coating syrup may be applied to smooth out the coating of the core portion and provide a shine thereto. The coating syrup may include ingredients similar to those present in the precoating but dispersed in water. In an embodiment, coating portion 14 may be formed by applying alternating layers of syrup and precoating until a desired coating thickness is obtained. Coating portion 14 may be formed by a panning process such as a soft panning process or a hard panning process, or spray process as is commonly known in the art.

In an embodiment, the coating portion may include inner layer 14a. Inner layer 14a may include a sensation producing ingredient and optionally, a sweetener. The sensation producing ingredient may include a cooling agent, a food grade acid, a flavorant, and combinations thereof. The cooling agent may include menthol, p-mentha-3,8-diol, 1-isopulegol, menthone ketals, menthyl lactate, monomenthol succinate, menthyl pyrrolidone carboxylate, 3-1-menthoxypropane-1,2-diol (Takasago Cooling Agent, TCA), N-ethyl-p-menthane-3-carboxamide (WS-3), 2-isopropyl-N, 2,3-trimethylbutyramide (WS-23), other cyclic and acyclic carboxamides and 3,3,5-trimethylcyclohexanol, other like cooling agents, or mixtures thereof. The sensation producing ingredient may be present in coating portion 14 and/or inner layer 14a.

In an embodiment, coating portion 14 delivers the sensation producing ingredient to the consumer's mouth before delivery of any flavor present in core portion 12 upon mastication of confectionery product 10. This advantageously contributes to the appeal of product 10 by providing a substantially instantaneous strong sensory burst or an invigorating flavor kick when the product is placed in the user's mouth. In an embodiment, the sensation producing ingredient may be a cooling agent that provides the consumer a strong, refreshing burst of coolness upon placement of product 10 in the mouth. Coating component 14 typically delivers the sensation producing ingredient to the consumer within about 1 second to about 10 seconds upon mastication.

In an embodiment, the sensation producing ingredient and/or the flavorant may be present in inner layer 14a. Upon mastication, outer hard coating component 14 breaks away from core portion 12 exposing inner layer 14a to deliver a strong dose of the sensation producing ingredient and/or flavors present in inner layer 14a. Provision of a granular sensation producing ingredient in inner layer 14a advantageously heightens or otherwise intensifies mouthfeel and the perception of the sensation producing agent's presence by the consumer further contributing to product appeal.

In an embodiment, a coated confectionery product may be provided that includes a first gelatin-based gel component having a first flavor and a second gelatin-based gel component having a second flavor. The first and second gel components may be combined to form a core portion as previously discussed. The confectionery product further includes a coating portion that encases the core portion. The first gel component may be prepared with a gelling agent that has a strong gel strength to provide the first gel component with a delayed flavor release. The second gel component may be prepared or otherwise contain a gelling agent that has a weaker gel strength when compared to the first gelling agent so that the second gel component has a substantially immediate flavor release upon mastication of the coated confectionery product. The coating portion may include a sensation producing ingredient that is delivered to the mouth of a consumer before delivery of the second flavor to the consumer's mouth.

Confectionery product 10 advantageously provides a confectionery product having a hard crunchy outer shell or coating and a chewy texture core portion. In an embodiment, gel strengths of the gelling agents in the gel components may be adjusted so that confectionery product 10 has an average mastication duration from about 3 minutes to about 10 minutes. In an embodiment, confectionery product 10 dissolves completely and leaves a well-balanced taste in the consumer's mouth. Confectionary product 10 thereby provides a candy with an appealing alternative to jelly beans and gummy candies that have average mastication durations of only about 1-2 minutes and chewing gum that has an average mastication duration of about 10-12 minutes. The sensation producing ingredient and flavors in the coating portion and the core portion deliver multiple flavors at distinct times during mastication further advantageously provide flavor waves and a product with long-lasting taste. This adds to the enjoyment of consumption of confectionery product 10.

By way of example and not limitation, examples of the present invention will now be given.

TABLE 1
PASTILLES

| COMPILED FORMULA | WT. % | ppm |
|---|---|---|
| MALITOL SYRUP | 40.3957.26 | |
| ISOMALT POWDER | 27.868963 | |
| SORBITOL 70/70 | 27.191945 | |
| GELATINE 250 BLOOM | 13.350207 | |
| BLACKCURRANT FLAVOR | 1.526933 | |
| CITRIC ACID | 0.784383 | |
| ARABIC GUM | 0.637005 | |
| METHOL POWDER BLEND | 0.597570 | 5975.70 |
| COCHINEAL CARMINE | 0.074851 | 29.94 |
| COLOR CHR HA | | |
| ASPARTAME | 0.065744 | 657.44 |
| ACESULFAME K | 0.031676 | 316.76 |
| NEOHESPERIDINE DC | 0.001794 | 17.94 |
| BRILLIANT BLUE 85% Dye | 0.000561 | 4.77 |
| ADDED WATER (after cooking) | 23.526470 | |
| Addition | 136.053827 | |
| cooking water loss | −15.658764 | |
| curing room water loss | −13.619817 | |
| coating water loss | −6.775246 | |
| TOTAL | 100.000000 | |

TABLE 2
PASTILLES

| | WT % |
|---|---|
| GEL COMPONENT | 77.650000 |
| COATING COMPONENT | 22.350000 |
| | 100.000000 |
| GEL COMPONENT | |
| COOKED POLYOLS MASS | 87.076449 |
| cooking water loss | −20.165827 |
| sub-total | 66.910622 |
| GELATINE SOLUTION | 46.467019 |
| CITRIC ACID SOLUTION | 2.020305 |
| ASPARTAME | 0.067344 |
| BLACKCURRANT FLAVOR | 1.966430 |
| COCHINEAL CARMINE | 0.094281 |
| COLOR CHR HA | |
| BRILLIANT BLUE 85% Dye 5% solution | 0.0 14007 |
| sub-total | 117.540009 |
| curing room water loss | −17.540009 |
| total | 100.000000 |
| COOKED POLYOLS MASS | |
| MALITOL SYRUP | 59.743855 |
| SORBITOL 70/70 | 40.215929 |
| ACESULFAME K | 0.0402 16 |
| | 100.000000 |
| GELATINE SOLUTION | |
| GELATINE 250 BLOOM | 37.000000 |
| WATER | 63.000000 |
| | 100.000000 |
| CITRIC ACID SOLUTION | |
| CITRIC ACID | 50.000000 |
| WATER | 50.000000 |
| | 100.000000 |
| ISOMALT POWDER | 25.105700 |
| ISOMALT SYRUP | 96.292482 |
| MENTHOL POWDER BLEND | 8.916117 |
| sub-total | 130.314298 |
| coating water loss | −30.314298 |
| Total | 100.000000 |
| ISOMALT SYRUP | |
| ISOMALT POWDER | 97.030937 |
| ARABIC GUM | 2.959870 |
| COCHINEAL CARMINE | 0.007627 |
| COLOR CHR HA | |
| BRILLIANT BLUE 85% Dye 5% solution | 0.001565 |
| | 100.000000 |
| MENTHOL POWDER BLEND | |
| ISOMALT PF | 69.022770 |
| MENTHOL POWDER | 29.987157 |
| ASPARTAME | 0.675049 |
| ACESULFAME K | 0.225016 |
| NEOHESPERIDINE DC | 0.090007 |
| | 100.000000 |
| BRILLIANT BLUE SOLUTION | |
| WATER | 95.000000 |
| BRILLIANT BLUE 85% Dye | 5.000000 |
| | 100.000000 |

Compiled Formula (Gel center and coating)

| | Example 1 | Example II | Example III | Example IV | Example V |
|---|---|---|---|---|---|
| Malitol syrup | 40.396 | 40.396 | 40.396 | 40.396 | 40.396 |
| Isomalt powder | 27.869 | 27.869 | 27.869 | 27.869 | 27.869 |
| Sorbitol 70/70 solution | 27.192 | 27.192 | 27.192 | 27.192 | 27.192 |
| Gelatin 180 bloom | 0 | 13.500 | 0 | 0 | 0 |
| Gelatin 250 bloom | 13.500 | 0 | 0 | 14.685 | 0 |
| Gelatin 325 bloom | 0 | 0 | 13.50 | 0 | 0 |
| Carrageenan iota | 0 | 0 | 0 | 0 | .900 |
| (with calcium) | | | | | |
| Water (added) | 23.526 | 23.526 | 23.526 | 23.526 | 23.526 |
| Flavors and coolants | 2.126 | 2.126 | 2.126 | 2.126 | 2.126 |
| Citric acid | 0.784 | 0.784 | 0.784 | 0.784 | 0.784 |
| Arabic gum | 0.637 | 0.637 | 0.637 | 0.637 | 0.637 |
| Color | 0.098 | 0.098 | 0.098 | 0.098 | 0.098 |
| High Intensity Sweetners | 0.098 | 0.098 | 0.098 | 0.098 | 0.098 |
| | 136.054 | 136.054 | 136.054 | 136.054 | 136.054 |
| | −36.054 | −36.054 | −36.054 | −36.054 | −36.054 |
| | 100.000% | 100.000% | 100.000% | 100.000% | 100.000% |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A coated confectionery product comprising:
a core portion having a gel component; and
a coating portion surrounding the core portion.

2. The confectionery product of claim 1 wherein the gel component further comprises an ingredient selected from the group consisting of a gelling agent, a sweetener, a flavorant, an encapsulated flavorant, a colorant, and combinations thereof.

3. The confectionery product of claim 1 wherein the gel component further comprises a gelatin, the gelatin present in an amount from about 10% to about 25% by weight of the confectionery product.

4. The confectionery product of claim 1 wherein the confectionery product is sugarless.

5. The confectionery product of claim 1 further comprising a first gel component and a second gel component.

6. The confectionery product of claim 1 wherein the core portion further comprises a first gel component surrounded by a second gel component.

7. The confectionery product of claim 6 wherein the first gel component further comprises a first flavorant and the second gel component further comprises a second flavorant.

8. The confectionery product of claim 5 wherein the second gel component delivers the second flavorant before the first gel component delivers the first flavorant when the confectionery product is placed in the mouth of a consumer.

9. The confectionery product of claim 7 wherein the first flavorant is delivered after substantially all of the second flavorant is delivered in the consumer's mouth.

10. The confectionery product of claim 9 further comprising a third gel component surrounding the second gel component, the third gel component delivering a third flavorant before the second component delivers the second flavorant.

11. The confectionery product of claim 5 wherein the first gel component has a first flavorant release rate and the second gel component has a second flavorant release rate, the first flavorant release rate being less than the second flavorant release rate.

12. The confectionery product of claim 5 wherein the first gel component includes a first gelatin and the second gel component includes a second gelatin and the first and second gelatins differ in a property selected from the group consisting of Bloom value, pH, viscosity, density, molecular weight, water activity, solubility, moisture content, and combinations thereof.

13. The confectionery product of claim 1 wherein the coating portion further comprises an ingredient selected from the group consisting of a sweetener, a flavorant, a film forming agent, a colorant, a sensation producing ingredient, and combinations thereof.

14. The confectionery product of claim 1 wherein the coating portion further comprises isomalt present in an amount from about 15% to about 98% by weight of the coating component.

15. The confectionery product of claim 1 wherein the coating portion is a hard coating.

16. The confectionery product of claim 1 wherein the coating portion further comprises an inner layer.

17. The confectionery product of claim 16 wherein the inner layer further comprises a sensation producing ingredient.

18. The confectionery product of claim 17 wherein the sensation producing agent is selected from the group consisting of cooling agents, food grade acids, flavorants, and combinations thereof.

19. The confectionery product of claim 17 wherein the sensation producing ingredient is delivered within about 1 second to about 10 seconds upon mastication.

20. The confectionery product of claim 1 wherein the confectionery product has an average mastication duration from about 3 minutes to about 10 minutes.

21. A coated confectionery product comprising:
a first gelatin-based gel component having a first flavor;
a second gelatin-based gel component having a second flavor, the first and second gel components forming a core portion; and
a coating portion encasing the core portion.

22. The coated confectionery product of claim 21 wherein the first gel component has a delayed flavor release and the second gel component has a substantially immediate flavor release upon mastication of the coated confectionery product.

23. The coated confectionery product of claim 22 wherein the coating portion includes a sensation producing agent, the coating component delivering the sensation producing ingredient to the mouth of a consumer before the second flavor release.

24. A method of delivering a plurality of flavors to the mouth of a consumer, comprising:
providing a coated confectionery product including a core portion having a first gel component with a first flavor and a second gel component with a second flavor, the core portion coated with a coating portion;
delivering upon mastication the first flavor from the first gel component upon mastication; and
delivering upon mastication the second flavor from the second gel component before the delivery of first flavor.

25. The method of claim 24 further comprising delivering substantially all of the second flavor before the delivering of the first flavor.

26. The method of claim 24 further comprising surrounding the first gel component with the second gel component.

27. The method of claim 24 further comprising:
preparing the first gel component with a first gelatin having a first flavor release rate; and
preparing the second gel component with a second gelatin having a second flavor release rate that is greater than the first flavor release rate.

28. The method of claim 24 further comprising:
preparing the first gel component with a first gelatin having a delayed flavor release;
preparing the second gel component with a second gelatin having an immediate flavor release; and
delivering substantially all of the second flavor before the delivering of the first flavor.

29. The method of claim 24 wherein the coating portion includes a sensation producing ingredient, the method further comprising delivering the sensation producing ingredient upon mastication of the confectionery product before the delivering of the second flavor.
